(19) United States
(12) Patent Application Publication
(10) Pub. No.: US 2005/0211100 A1
(43) Pub. Date: Sep. 29, 2005

(54) Shaped composite adsorbent material

(76) Inventors: David T. Doughty, Moon Township, PA (US); John W. Cobes, Harmony, PA (US)

Correspondence Address: COHEN & GRIGSBY, P.C., 11 STANWIX STREET, 15TH FLOOR, PITTSBURGH, PA, 15222, US

(21) Appl. No.: 11/077,070

(22) Filed: Mar. 10, 2005

Related U.S. Application Data
(63) Continuation-in-part of application No. 10/807,375, filed on Mar. 23, 2004.

(51) Int. Cl. B01D 53/02

(52) U.S. Cl. 96/154

(57) ABSTRACT

A composite adsorbent includes a substrate to which an adsorbent material has been immobilized. The composite adsorbent is designed to be shaped into a variety of forms that provide a high adsorption capacity, low pressure drop, high volume capacity, and fast adsorption kinetics to effectively adsorb contaminants. Optionally, the composite adsorbent is also used in combination with an air permeable unit wherein it is advantageously positioned to provide enhanced adsorption of contaminants found in gas phase.

### RELATED PATENT APPLICATION

This is a continuation in part of U.S. patent application Ser. No. 10/807,375 filed Mar. 23, 2004 entitled Spiral Composite Adsorbent Material.

### FIELD OF INVENTION

This invention relates to a composite for the treatment of a fluid stream, and more particularly, to a shaped composite adsorbent or device containing a shaped composite adsorbent.

### BACKGROUND OF THE INVENTION

Devices containing adsorbent materials for removing contaminants from fluid streams are known. Such devices may remove odors or purify ambient air. Some are used to remove contaminants from commercial and industrial gas streams. Others are used remove contaminants from liquid streams. The current invention can be used with any solid material. Typically these devices include an adsorbent material such as calcium phosphate, sodium bicarbonate powder, baking soda, silicas, aluminas, zeolites, or charcoal or carbon particles, wherein the adsorbent is provided as a bed of packed particles or pillow of bulk adsorbent. Such an arrangement, however, decreases the accessibility of the adsorbent to the fluid stream to be treated. A significant amount of adsorbent may be required to provide effective adsorption. This can require a sizeable device to accommodate the adsorbent or a smaller sized one that is more frequently replaced. The pressure drop across a packed bed of adsorbent will also be higher because of the higher density of the packed bed compared to an expanded bed.

G.B. Pat. No. 1,476,761 discloses a composite that uses layers of activated carbon cloth (ACC) spaced apart with granular activated carbon (GAC) particles that are bonded to the cloth to provide reduced pressure drop. Similarly, U.S. Pat. No. 4,234,326 employs ACC, but the spacer particles are an inert material with no adsorption capacity. In both cases, the ACC substrate is a cost prohibitive material. Another approach is to apply a slurry of the particulate material and adhesive to a substrate. In this case, the adhesive decreases the capacity of an active particulate material by coating it. U.S. Pat. No. 4,604,110 recognizes the problem of increased pressure drop as the thickness of a layer of adsorbent material increases. Although it notes the advantages of minimizing the pressure drop, the inventor does not recognize a shaped composite solution to the problem. U.S. Pat. No. 5,120,331 describes a device that uses a permeable fibrous material or fabric embedded with activated carbon or some other functional particulate material that is wound about a center structure. However, without reliance on a porous substrate, this device could not function as described. U.S. Pat. No. 6,569,494 describes the application of carbon onto an adhesive tape substrate. The author does not suggest using the substrate as a filter media.

U.S. Pat. Nos. 5,582,865, 5,779,847, and 6,024,813 describe processes wherein functional particulate materials are adhered to fibrous substrate materials using a dry bonding process. Again, these processes are made exclusively with fibrous materials. Further, they require multi-step processing and involve the forming of multiple mats, the use of specific blends of specific fibers, special manipulation to distribute the particulate throughout the mat, multiple heating stations, cooling, etc.

Thus, there is a need for an adsorbent composite which efficiently utilizes the adsorbent to effectively adsorb contaminants from fluid streams over an extended period of time. The adsorbent composite should also show high adsorption capacity, low pressure drop, high volume capacity, and fast adsorption kinetics, and that can be produced using standard or simplified manufacturing techniques. Despite the range of prior art describing prior adsorbent devices, it has not been previously recognized that the performance of an adsorbent composite can be dramatically enhanced by altering the shape of the composite media that is produced on a solid (non-porous) substrate.

### SUMMARY OF THE INVENTION

The present invention is directed to a composite adsorbent that includes a shaped substrate having an adhesive material on a portion of one or both sides thereof, and an adsorbent that has been immobilized as a layer on the substrate adhesive portion. The composite uses a functional solid material that is capable of removing contaminants including odors from a fluid stream. Fluid streams can include any kind of fluid such as gas, vapor, liquid, for example. The invention is also directed to a composite adsorbent that can be used in combination with an air permeable housing.

The present invention represents a substantial advance over prior composite adsorbents or devices. The present invention requires a substrate shaped into a spiral, disc, cylinder, or otherwise folded over on itself. The composite can also be in the form of a stack of strips or sheets. In any of these forms, this novel composite provides an advantage in that it improves access to the particulate material by comparison to a packed bed of material. It does so for example by providing a layer of particulate material along a substrate which thereby opens up the packed bed and increases the accessibility of the adsorbent material to the contaminants to be removed from the stream. Because only a minimal amount of the surface area of the particulate is used to secure it to the substrate, the capacity of the particulate remains close to that of bulk material particulate.

The current invention does not require the application of spray adhesives or the handling of powders to realize the advantages of maximizing the surface area of the particulate adsorbent material as required by traditional devices. Thus, dusting is also minimized by the immobilization of the particulate material. Unlike traditional devices, the invention uses a unique substrate comprised of a non-porous material. In an embodiment, the present invention has the further advantage that the adsorbent composite is used in a device having a form that is more practical to handle, more space efficient, and more attractive for a consumer product. Because of the unique construction, this composite can realize high adsorption capacity, fast adsorption kinetics, high volume capacity, low dusting, low pressure drop, and low cost.

The invention also has the advantages of being non-toxic and containing no chemicals. The current invention is capable of adsorbing odors, not just covering them up. Another advantage of an embodiment of the present invention is that the composite can be made with simple manufacturing processes and low cost, readily available materials such as adhesive tape and activated carbon. The device effectively treats the stream and adsorbs contaminants over an extended period of time. Those and other features and advantages of the present invention will become apparent form the following description, drawings and claims.

### BRIEF DESCRIPTION OF THE DRAWINGS

The accompanying drawings illustrate examples of embodiments of the invention. In such drawings:

FIG. 1 shows a perspective view of an embodiment of the substrate partially coated with particulate.

FIG. 2 shows a rolled embodiment of the shaped composite adsorbent.

FIG. 3 shows another embodiment of the shaped composite adsorbent.

FIG. 4 shows a side view of an embodiment of the shaped composite adsorbent.

FIG. 5 shows a cut-away pie section of an embodiment of the shaped composite adsorbent.

FIG. 6 shows an air permeable housing enclosing a shaped composite adsorbent in an embodiment of the present invention.

FIG. 7 shows a stacked embodiment of the shaped composite adsorbent.

### DETAILED DESCRIPTION OF THE INVENTION

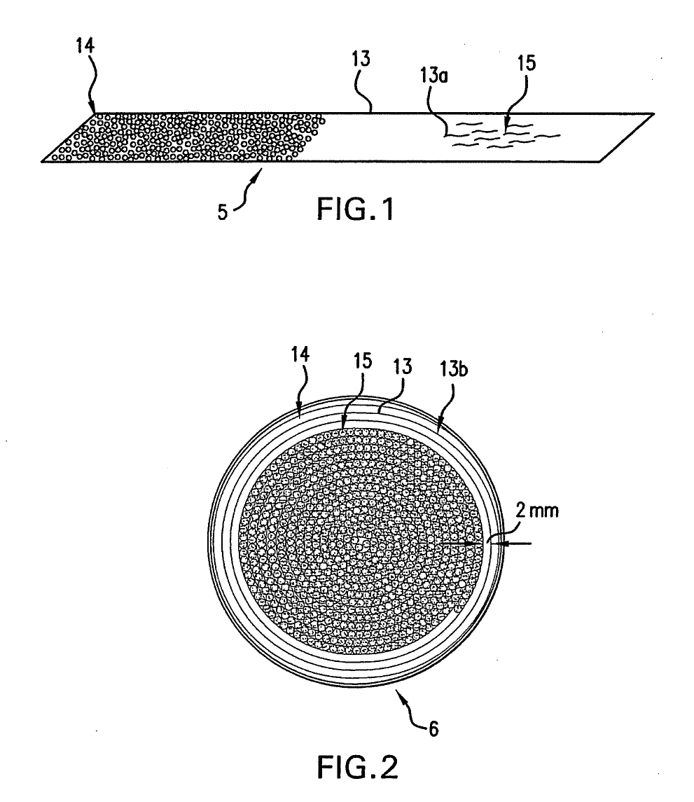

As shown in the drawings for purposes of illustration, the present invention comprises a novel, shaped, composite adsorbent. As generally shown in FIG. 1, composite 5 comprises a substrate 13 capable of being formed or wound into a compressed shape, for example a coil or a spiral shape, to which a layer of adsorbent material 14, such as activated carbon, has been applied.

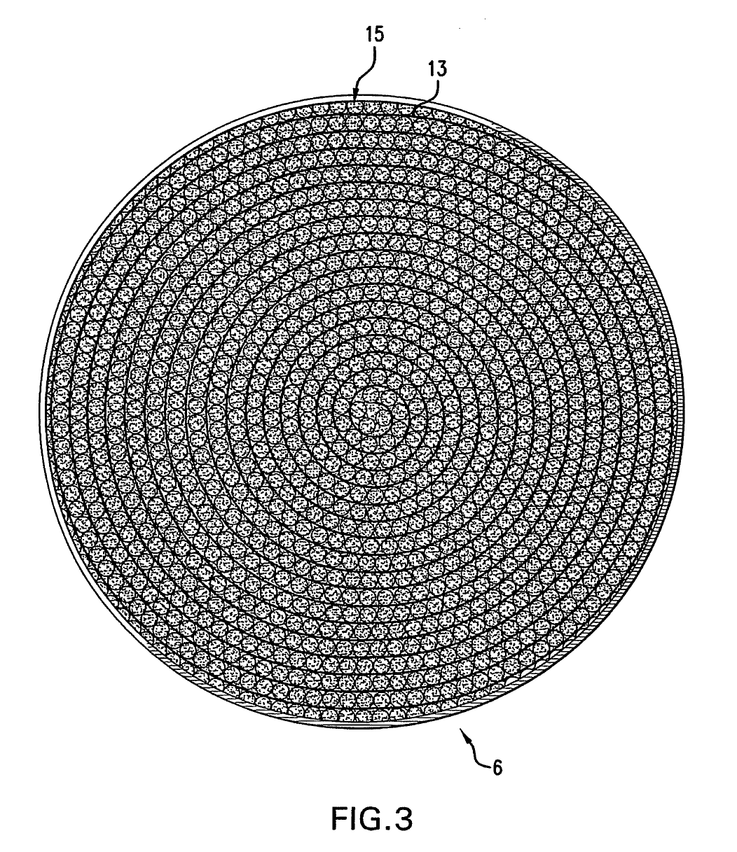

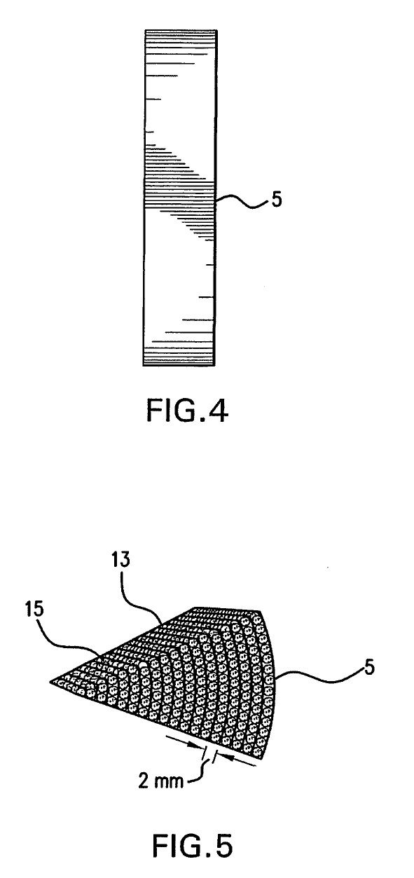

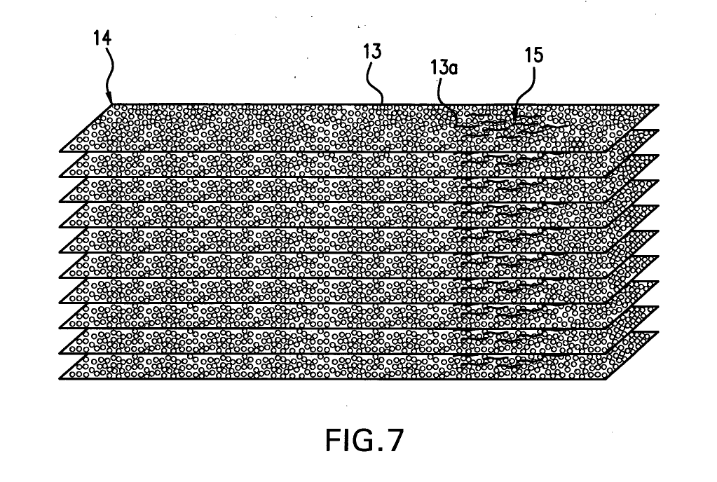

In an example, substrate 13 is fabric, cloth, metal or polymer film, or a rigid substrate that is capable of being stacked. The substrate has at least one adhesive side 13a to which an adhesive material 15 is or has been provided. In one example of a specific embodiment, the substrate plus adhesive is in the form of a traditional adhesive tape or metal tape. Adsorbent 14 is applied along substrate adhesive side 13a. Alternatively, adhesive 15 may be an integral part of substrate side 13a. In this example, the adhesive can be a low melting thermoplastic film that can be softened to an adhesive like state through the application of heat. In an example, adsorbent 14 is applied to produce a uniform distribution. Preferably, adsorbent 14 is applied as a mono-layer on adhesive 15. Composite 5 is then shaped so that the adhesive adsorbent coated side 13atouches a non-adhesive side 13b of substrate 13. Substrate 13 may be folded over once or multiple times, or provided to have a corrugated or pleated shape. Substrate 13 may also be wound into a coil or spiral form as shown, for example, in FIG. 2-FIG. 5. It can be used as a folded sheet, layers of sheets, a ribbon, layers of ribbons, roll, etc. depending upon desired application. The shaped composite can also be prepared by stacking strips or sheets of the composite that have been prepared using either a flexible or a rigid substrate as shown for example in FIG. 7.

Adsorbent composite 5 is prepared by the application of the adsorbent material 14 to adhesive 15 of the adhesive side 13a of substrate 13. Suitable materials for substrate 13 include polymeric films such as acrylics, polycarbonates, polyimides, polyphenylene ether, polyphenylene sulfide, acrylonitrile-butadiene-styrene copolymers (ABS), polyesters, ethylene vinyl acetate (EVA), polyurethanes, polyamides, polyolefins, polystyrenes, blends and derivatives thereof. Substrate 13 can also comprise wood, metal, foil, glass, rubber or composites thereof. It may also be a thermoplastic substrate that can act as both adhesive and substrate.

Suitable adhesives 15 include acrylics, vinyl ethers, natural or synthetic rubber-based materials, poly (alpha-olefins), and silicones. The substrate and adhesive are chosen in such a way as to minimize cost but also to meet the strength, temperature, humidity, and chemical resistance requirements of a given application. In an example of an embodiment, the flexibility characteristics of the substrate are important so that the composite can be manipulated and used in one of variety of forms such as a spiral.

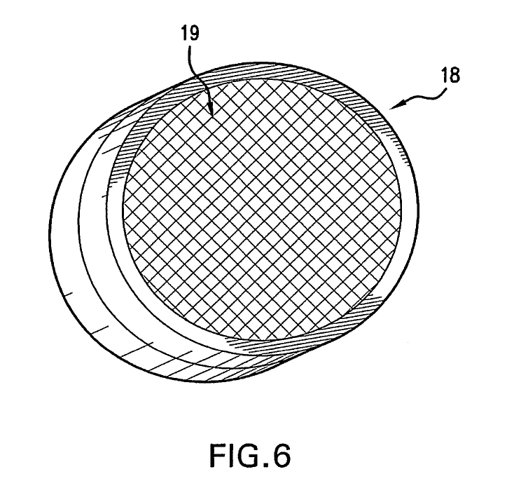

The substrate is sized and shaped to accommodate a particular application. It may be coiled to accommodate and fit within an enclosure 18 as shown for instance in FIG. 6. Enclosure 18 may optionally be used in combination with a filtration unit. For some applications it is shaped into a long cylindrical form having a small diameter for use, for example, inside a pipe or drum. With smaller applications it can be shaped into a disc form having a generally narrow width and a larger diameter. For an example, a disc shaped substrate is used measuring about 100 to 150 linear inches having width ranges from 0.25 inches to 1.0 inch wide. Any number of discs can be stacked to achieve virtually any desired bed depth or application.

Suitable adsorbent materials 14 include activated carbons, impregnated activated carbons, silicas, natural and man-made zeolites, molecular sieves, clays, aluminas, or ion exchange resins. Materials 14 may also consist of an adsorbent material that is used a carrier for solid catalysts such as gold, silver, palladium, or ruthenium to name a few. Any solid adsorbent material, regardless of particle size, can be applied to the adhesive side 13a of substrate 13. The solid materials can be used alone or as mixtures. A series of spirals, each containing a different material, can be used as a stack to provide enhanced performance. The inventors have discovered that the spiral construction enables a low pressure drop which is enhanced, and thus especially advantageous, when multiple spirals are stacked together. In an example, the current invention is used as an adsorber of vaporous contaminants. It can also be used for neutralization of corrosive vapors in a gas stream or as a catalyst support which can either promote gas phase reactions or the catalytic destruction of vaporous contaminants in a gas stream.

In another example of an embodiment, the current invention employs activated carbon adsorbent. Any type of activated carbon product, including impregnated products, can be used with this invention. A preferred product is BPL activated carbon from Calgon Carbon Corporation. Activated carbons ranging in size from U.S. mesh 4×10 to 20×45 have been successfully used with comparable results. Fibrous substrates require the use of specific materials, such as mesh materials such as mats. For example, a lofted or expanded non-woven, fibrous mat may be used. The larger particles can sit on top of the mat and small particles can fall completely through the mat. In an example, substrate 13 is fully loaded with carbon 14 by saturating adhesive side 13a in a bed of carbon and manually applying pressure to the non-adhesive side 13b of substrate 13 to adhere as much carbon to the adhesive 15 as possible. Alternatively, appropriate equipment is used to accurately dispense metered amounts of carbon onto the adhesive.

In preferred embodiments, the composite tape is rolled into a spiral disc or cylindrical form so it can be enclosed in a disc, a cylinder, or any other type of air-permeable housing that will accept the composite spiral. For example, the spiral composite can be built into a rectangular frame for use in rectangular duct work that could be found in homes or in commercial buildings. Square filters can also be built with layers of square sheets or layers of ribbons. By this means, a home can be deodorized or a commercial building could be protected from any number of vaporous nuisance materials or toxins. This same means can be used to help remove solvents from an industrial work place to maintain work place safety standards and environmental emissions standards. In another example, the spiral composite is also useful in a device such as a gas mask where low pressure drop is desirable. The compact nature of this novel composite makes it amenable to various applications that may not necessarily be effectively addressed by traditional adsorbent devices.

The current invention is also well suited for static applications such as a deodorizer. In an embodiment, the composite is coated with adsorbent materials, rolled into a spiral form and enclosed in a housing that is attractive to the consumer eye, space efficient, and practical for consumer use. The housing is preferably made from readily available thermoplastic materials. It is designed with openings 19 that allow the odiferous air to come in contact with the adsorbent materials. The housing is made with a simple clam-shell design for easy assembly. In an example, the housing unit includes a disc that is about one inch wide and 3.5 inches in diameter. Because of the long-time performance of the device and the low cost, the device is completely disposable. The consumer does not have to purchase and store replacement cartridges. Alternatively, a more durable unit may be designed for longer lasting use that has replaceable cartridges when adsorption power declines or less than desirable. Depending on conditions, it is anticipated the cartridges may work for two weeks to a year. The deodorizer can be used, for example, to adsorb odors in refrigerators and other closed spaces such as closets, lockers, gym bags, shoes, tackle box, garbage cans, etc.

Gas streams that can be treated include, for example: ambient air, industrial gases such as nitrogen, oxygen, and hydrogen, or organic gases such as methane, ethylene, acetylene, etc. Standard activated carbon materials can be used for treatment of such streams. A list of impregnated activated carbon materials has been developed over the years to meet the special requirements of treatment in specific applications. These materials can be used with the current invention. The current invention can also be used in combination with other purification materials, either individually or as mixtures. Combination with a fibrous filter material creates a unit that would not only remove vapors but would also remove particulates from ambient air or any other gas stream. Combination with a water adsorbing zeolite creates a unit that would remove not only vapors but would also dehumidify ambient air or any other gas stream. For example, a series of three composites are stacked consecutively or alternatively with space between them, each having a different adsorbent, such as carbon, zeolite and silica gel. One or more of the composites may have different thicknesses to provide capacities geared to the use of that adsorbent in the desired application.

These examples are not meant to limit the uses of the present invention. The dimensions of the substrate and shaped composite are anticipated to vary greatly depending upon the desired use and particular application. Those skilled in the art will appreciate the variances and realize the utility and wide range of uses for such a novel adsorbent material used alone or in combination with particulate filters or other adsorbent materials.

### Example 1

An adsorbent device was created by pressing the adhesive side of a strip of ½″ SCOTCH® Magic™ Tape 810 into a tray of granular carbon and completely coating the adhesive with the carbon. The substrate tape measured 113 linear inches. The carbon was a U.S. 20×45 mesh BLP granular activated carbon from Calgon Carbon Corporation having an apparent density of 0.540 g/cc. The coated composite was wound into a tight spiral measuring about 3.5 inches in diameter to create a spiral adsorbent composite. The spiral was enclosed in an air permeable, disc-shaped prototype housing 18, as shown for example in FIG. 6. Housing 18 has air permeable faces 19 on both the front and back sides of the disc. Tests were conducted on this prototype unit. The carbon density of the spiral composite was 0.181 g/cc. This density was selected to optimize a balance between increasing access to the carbon while maintaining a high volumetric carbon density. As a result faster adsorption kinetics were obtained while maintaining a high adsorption capacity for the spiral composite unit.

A butane activity test was carried out to determine the capacity of both the loose, bulk carbon and the spiral adsorbent composite by evaluating the grams of butane adsorbed per 100 grams of carbon. For this test, each item was in placed in contact with a stream of butane gas. The test was conducted on a prototype unit that was a disc that was 0.5″ wide and 3.5″ in diameter. Two petrie dish bottoms with most of the face cut out were used. The hole was covered with a plastic mesh screen and the spiral was inside. The plastic mesh screen simulated the air flow perforations that will be molded into the housing. After exposing them to the test, the items were weighed after 20 and 40 minutes of exposure (although in most cases the carbon is already saturated after a 20 minute exposure). The butane activity of the bulk carbon was 24.04 g butane/100 g carbon. The butane activity of the carbon in the spiral adsorbent composite was 22.30 g butane/100 g carbon. The capacity loss would be much greater in a system where the carbon was coated with an adhesive and then applied to the substrate because the liquid adhesive plugs a large percentage of the pores in the carbon. The actual butane activity of the spiral adsorbent composite was 4.18 g butane adsorbed/spiral unit.

The kinetic performance of the spiral adsorbent composite was also measured. This test shows how quickly odors will be adsorbed by a given adsorbent or a given odor adsorbing device. This test was a modification of the butane adsorption test where the weight gain due to adsorption of the butane was monitored with time and not just measured at the final saturation level. The spiral adsorbent composite adsorbed 2.3 grams of butane in 30 minutes.

Unlike traditional adsorbers or deodorizer units that use loose, bulk granular carbon, the adsorbent composite and results of these tests showed the granules do not grind against each other during use. Thus, with the current invention, dusting is decreased as a result of the immobilization of the carbon granules.

### Comparative Example 1

A commercially available refrigerator deodorizer was tested for comparison with the prototype unit prepared and tested in Example 1. The commercial deodorizer contained carbon in the form of a hollow extruded cylinder of “Activated Charcoal”. The deodorizer was subjected to a butane activity test, as described in Example 1. The test revealed the butane activity of the activated charcoal inside the deodorizer was 3.7 g butane/100 g activated charcoal. This compares to a butane activity of 22.3 g butane/100 g activated carbon attached to the substrate with the current adsorbent composite invention; a 6 fold increase in the capacity of the carbon to adsorb odors. The butane activity of the full commercial deodorizer unit was 0.30 g butane/unit. This compares to a butane activity of 4.18 g butane/unit with the current invention; a 14 fold increase in the capacity of the unit to adsorb odors. These results illustrate how the unique construction of the current invention results in a much higher carbon adsorption capacity and a much higher unit capacity when compared with another deodorizer. This, in turn, results in a more efficient deodorizer device with a significantly longer service life.

### Comparative Example 2

In this example, the kinetic test was performed as described in Example 1. It was conducted to compare the kinetics of the current invention with a pile of carbon adsorbent to show how quickly odors will be adsorbed by a given adsorbent or a given odor adsorbing device. The same type of carbon and the same amount of carbon that was contained in the prototype unit of Example 1were used for the test. An open pile of loose, bulk carbon was used for the test. In 30 minutes, the loose carbon had only adsorbed 1.7 grams of butane while the carbon spiral had adsorbed 2.3 grams of butane in the same period of time. That represents a 35% increase in the rate of butane adsorption because of the enhanced access to the carbon granules. If a deodorizer is slow to adsorb the odors in a refrigerator, they could be adsorbed by other foods or ice cubes before they are captured by the deodorizer. These results clearly demonstrate the improved kinetics of the current invention and therefore, the improved efficiency as a vapor adsorption device for static or forced air applications. This is especially true for refrigerators and freezers since they do have intermittent air circulation.

### Example 2

In another experiment, the pressure drop was measured for a constant mass of 8.93 grams of carbon in the forms of a spiral composite, and a packed bed of bulk carbon. The spiral composite opens up the carbon bed and immobilizes the carbon in space thereby lowering the pressure drop across the bed. The bulk carbon bed was prepared to have a bed depth of 1.7 cm while the spiral composite spread the same amount of carbon out to a bed depth of 3.0 cm. This test demonstrated that a result of spreading the carbon bed out provided a significant reduction in the pressure drop of the bed. The test was conducted using 80 ppm butane in an air stream at 50% relative humidity and 0.6 m/sec linear velocity. The pressure drop of the packed bed of carbon was 1.010 inches of water while the pressure drop with the spiral construction bed was 0.095 inches of water. This represents a 10 fold decrease in the pressure drop which is desirable for many applications. The lower pressure drop is desirable because forced air filtration systems can be designed with smaller, cheaper blowers which consume less energy. This reduces the cost of a filtration unit, the space required, and the operating costs. For other applications that are already designed to handle higher pressure drops, the spiral design allows for the use of higher flow rates, and therefore higher treatment rates. This results in more efficient equipment utilization and therefore lower operating costs.

### Example 3

The flow rate of water through a water column was used to demonstrate the reduced pressure drop of the current invention with a liquid system. Using only gravity, a 9 inch water column was allowed to drain through the carbon bed and out of the column. Each column contained 238 grams of activated carbon. The column with the packed bed drained in 22.2 seconds and the column with the spiral composite carbon bed drained in 17.5 seconds. The result is a 21% increase in flow rate. This rate was achieved without addition of any pumps.

While the present invention has been described in conjunction with several embodiments thereof, many modifications and variations will be apparent to those of ordinary skill in the art. The foregoing description and the following claims are not intended to cover all such modifications and variations.

1. A shaped composite adsorbent comprised of a nonporous substrate having an adhesive on a portion of at least one side thereof, and an adsorbent that has been immobilized as a layer on said adhesive portion of said substrate.

2. A composite adsorbent as set forth in claim 1 wherein said substrate is a flexible material that can be rolled, folded, or stacked into a shape, or a rigid material that can be stacked in layers, and wherein said substrate can be used as a folded sheet, layers of sheets, a ribbon, layers of ribbons, or roll.

3. A composite adsorbent as set forth in claim 1 wherein said adsorbent is selected from the group consisting of activated carbon, impregnated activated carbons, silicas, natural and man-made zeolites, molecular sieves, clays, aluminas, catalyst carrying adsorbents, or ion exchange resins.

4. A composite adsorbent as set forth in claim 2 wherein said adsorbent is granular activated carbon.

5. A composite adsorbent material as set forth in claim 1 wherein said substrate is a pressure sensitive adhesive tape.

6. A composite adsorbent as set forth in claim 1 wherein said substrate is selected from the group consisting of material, fabric, cloth, metal, polymer film, thermoplastic, wood, metal, foil, glass, rubber, and composites thereof.

7. A composite adsorbent as set forth in claim 1 where said polymer film is selected from the group consisting of acrylics, polycarbonates, polyimides, polyphenylene ether, polyphenylene sulfide, acrylonitrile-butadiene-styrene copolymers (ABS), polyesters, ethylene vinyl acetate (EVA), polyurethanes, polyamides, polyolefins, polystyrenes, blends and derivatives thereof.

8. A composite adsorbent as set forth in claim 1 wherein said adhesive is selected from the group consisting of acrylics, vinyl ethers, natural or synthetic rubber-based materials, poly (alpha-olefins), and silicones, or a meltable thermoplastic.

9. A composite adsorbent as set forth in claim 1 wherein said shaped substrate is in the shape of a spiral, disc, cylinder or otherwise shaped so that said adsorbent contacts a side of said substrate that does not contain adsorbent.

10. A composite adsorbent as set forth in claim 1 wherein said shaped substrate is the form a stack of strips or sheets.

11. A composite adsorbent as set forth in claim 1 in combination with an air permeable housing.

12. A composite adsorbent as set forth in claim 11 wherein said housing includes an impermeable unit having a screen, holes, open lattice structure, or permeable fabric portion.

13. A composite adsorbent as set forth in claim 1 wherein said adhesive is a low melting polymeric film that is an integral part of said substrate or acts as the substrate itself.

14. A composite adsorbent as set forth in claim 1 wherein said substrate is used in combination with one or more additional said substrates.

15. A method for making a shaped composite adsorbent for treatment of fluids comprising:
a. sizing a substrate for said application having an adhesive on a portion of at least one side thereof; b. coating said substrate adhesive portion with adsorbent;
C. rolling, folding, or stacking the composite to obtain a desired shape.

16. A method for making a composite adsorbent as set forth in claim 15 wherein said coating substantially coats said substrate adhesive portion with said adsorbent to provide high particulate loading of said adsorbent.

17. A method for making a composite adsorbent as set forth in claim 15 including a further step of combining said composite adsorbent with one or more of said composite adsorbents.
